(19) United States
(12) Patent Application Publication
(10) Pub. No.: US 2013/0168332 A1
(43) Pub. Date: Jul. 4, 2013

(54) ADJUSTABLE FILTER APPARATUS

(71) Applicant: Delcath Systems, Inc., New York, NY (US)

(72) Inventors: William M. Appling, Granville, NY (US); Stephen N. Engelhard, Queensbury, NY (US); Matthew G. Barton, Wilton, NY (US)

(73) Assignee: DELCATH SYSTEMS, INC., New York, NY (US)

(21) Appl. No.: 13/731,019

(22) Filed: Dec. 30, 2012

Related U.S. Application Data
(60) Provisional application No. 61/581,433, filed on Dec. 29, 2011.

(51) Int. Cl. B01D 29/66

(52) U.S. Cl. CPC B01D 29/66
USPC 210/797; 210/409; 210/332; 210/791

(57) ABSTRACT

A filter apparatus for removing contaminants from a fluid and having an internal chamber with an adjustable volume is provided. Filter media priming to dislodge trapped gas is facilitated by the filter apparatus. A method of priming a filter cartridge containing a filter media is also provided.

### CROSS-REFERENCE TO RELATED APPLICATIONS

This application claims priority benefit of U.S. Provisional Patent Application Ser. No. 61/581,433 filed Dec. 29, 2011, and entitled “ADJUSTABLE FILTER APPARATUS.” The disclosure of the aforementioned Provisional Patent Application Ser. No. 61/581,433 is hereby incorporated by reference in its entirety.

### BACKGROUND

Removing toxic compounds from blood, and other biological fluids, is an area of great importance for human health. Filters for adsorption of toxic compounds from blood are known. For example, extracorporeal filters in dialysis treatments and in removing chemotherapeutic drugs from the blood stream during cancer treatments have been in use for some time.

Filtration apparatus used in blood filtration procedures, especially in association with extracorporeal blood filtration treatments, require a priming procedure before the filter is ready to use. For blood filtration procedures, priming involves washing the filter media with saline solution, or other biologically compatible solution, to remove trapped air, or other gases, and fine particulate matter in the filter media before blood can be introduced. In the case of blood filters, priming often is accomplished by flushing with as much as 5 to 10 liters of saline to remove trapped air, or other gases, and fine particulate matter in media before blood can be introduced.

One aspect of the filter priming procedure that often slows the procedure and results in the excessive use of saline solution is the removal of air, or gas, bubbles that become trapped in the filter media. Air, or other gases in a non-air environment, gets trapped in the filter media and forms bubbles when the filter priming solution is introduced to dry filter media in a filter cartridge. Removing these bubbles is very important for filter performance because the presence of these air bubbles is responsible for a reduction in contact with the filter media resulting in losses of filter efficiency, restriction of flow, and increased pressure in the filter. Also, where extracorporeal blood filtration is being conducted, it is important to be sure that the air is not introduced into the patient's blood stream.

Valuable time, materials and efforts are expended to dislodge trapped air, or other gas, bubbles in filter media during the filter priming process. Medical practitioners and skilled technicians using current approaches to filter priming spend precious time working out the bubbles in filter media by carrying out manipulations such as tapping the filter cartridge, or housing, and varying the flow rates of priming solution through the filter to dislodge the bubbles. This approach is tedious, time consuming, and creates an unnecessary distraction. Filter priming is also important in nonmedical filter applications.

Accordingly, there is a need for filter apparatus, systems, and methods that make filter priming easier, faster, cheaper, and more efficient.

### SUMMARY

We have recognized that the problem of gas bubbles being trapped in filters and/or filter media during the priming process could be solved by changing the volume in which the filter media resides. Our solution to the problem of bubbles being present in the filter media is that during priming, or a part of the priming process, the filter media is held in an expanded volume such that bubbles that formed on introduction of a filter priming solution such as saline will easily be released. Providing a larger volume to filter media ratio, a prime state, during the priming process allows for the rapid release of air bubbles shortly after the filter priming solution is introduced to the filter. Once the filter bubbles have been released, further priming to remove fine particulate matter can proceed smoothly. After removal of the bubbles, the volume in which the filter media resides is changed to a ratio appropriate for filtering, a filter state.

Our novel solution to the problems associated with filter priming due to trapped air is to in some embodiments of the invention provide a filter apparatus whereby a fixed amount of filtration media is contained in a variable volume filter cartridge, or other kind of filtering unit, where there is a means for changing the volume in which the filter media resides. Such an apparatus, in some embodiments, is designed to switch from a prime state, where the internal chamber of a filter cartridge has an increased volume for filter media to reside, to a filter state, where the internal chamber of the filter cartridge has a volume decreased from that of the internal chamber in the prime state and wherein the filter will be effective, the filter state. Our solution also is to provide a general method of filter priming by changing the volume in which the filter media resides such that the filter media is in a larger volume prime state during priming, or for just long enough to release trapped bubbles, and once the trapped bubbles have been released, the volume in which the filter media resides is reduced to a volume effective for filtering, a filter state.

While the approach provided herein is applicable to any filter system where filter priming is slowed by the presence of trapped air, or other gas, an important application is blood filtration. Applications directed to extracorporeal blood filtration are particularly valuable since in extracorporeal blood filtration, blood filtration is part of medical procedures where reduced time in filter priming would greatly improve patient care.

Our elegant solution to the problems associated with priming filters is a departure from other approaches used in the art. Because of the importance of maintaining a proper ratio of total volume, or filter cartridge volume, to filter media volume in filtration procedures the approach we have taken is both surprising and unexpected. Prior to our discovery, persons of skill in the art would not have considered varying the volume in which filter media resides in filtration procedures. Our approach is to increase the volume in which the filter media resides to create a prime state in which trapped air bubbles are easily released. Once priming is completed, the filter cartridge volume is reduced to provide a ratio of filter cartridge volume to media volume that is effective for filtration, the filter state.

In some embodiments of the invention, the changing of the volume between a prime state and a filter state is accomplished by changing the volume of a filter cartridge holding filter media in its internal chamber. In some embodiments of the invention, a filter apparatus is provided that can change the volume of a filter cartridge having an internal chamber such that the filter cartridge has a variable volume and can be in a prime state, where the volume of the internal chamber is suitable for priming a filter, and a filter state, where the volume of the internal chamber is suitable for filtration. In the prime state trapped air can easily escape due to flow and buoyancy characteristics of the mixture and flushing of the filter to remove particulate matter can be easily carried out with a minimum of priming solution, such as saline solution, being passed through the filter. For effective filtering, a filter cartridge, or filter, should be in filter state since in prime state filtration would be less efficient due to channeling and reduced filter media contact.

In some embodiments, the invention provides a filter housing that holds one or more filter cartridges and can change the internal chamber volume of one or more filter cartridges that contain a fixed volume of filter media such that the filter cartridges can have their internal chamber volumes changed between an increased volume prime state suitable for filter priming and a decreased volume filter state suitable for filtering. In some embodiments of the invention a filter apparatus for removing toxic compounds from a biological fluid is provided which comprises a filter cartridge with a first end and a second end, an inlet and an outlet, an internal chamber with filter media, and means for adjusting the volume of the internal chamber. In some embodiments, the means for adjusting the volume of the internal chamber of the filter cartridge is a structure such as a piston engaged with the walls of the internal chamber of the filter cartridge by means of a seal that is moved through the internal chamber. In some embodiments, the means for adjusting the volume of the internal chamber of the filter cartridge can comprise telescopically arranged tubes that can move in and out of each other to change the volume of the internal chamber of the filter cartridge that they comprise.

In some embodiments, the means for adjusting the volume of the internal chamber of the filter cartridge can comprise a tube or other structure made from an elastomeric material that can stretch axially and recover/return in size in order to change the volume of the internal chamber of the filter cartridge that they comprise. In some embodiments, the elastomeric material that can stretch and recover/return in size can return to its original length. In some embodiments, the means for adjusting the volume of the internal chamber of the filter cartridge can comprise a tube or other structure made from an elastomeric material that can inflate or expand radially and recover/return to its original diameter in order to change the volume of the internal chamber of the filter cartridge that they comprise. In some embodiments, the radial expansion can be produced automatically by increasing the internal chamber pressure such that the internal pressure of the filter cartridge tube is of sufficient strength to stretch and expand the filter cartridge tube radially, thus creating a balloon like shape, that allows for priming of the filtration media. In some embodiments, this expansion can be restricted by placing a rigid sleeve over the filter cartridge tube in order to create an optimal priming volume.

Filter media that can be used with embodiments of the invention include any filter media that requires priming or increased volume for purging. Examples of filtration media include activated carbon or activated charcoal, ceramics, polymer based filtration resin, sand and zeolites. In some embodiments of the invention the filter media is useful for removing toxic substances from a biological fluid such as blood. In some embodiments of the invention the filter media is an activated carbon that is coated with a hydrogel such that the filter media is hemo-compatible. In some embodiments of the invention the hydrogel is a methacrylate.

In some embodiments of the invention, the toxic substance that is removed by the filter is a chemotherapeutic agent. In some embodiments of the invention the chemotherapeutic agent is melphalan. In other embodiments the chemotherapeutic agent is doxorubicin, fluorouracil, cisplatin, floxuridine, gefitnib, tamoxifen, or topotecan, and the like. Any chemotherapeutic agent that can be filtered from blood by the apparatus and methods disclosed herein is within the scope of some embodiments of the invention.

In some embodiments of the invention, the filter cartridge has a generally cylindrical shape. In some embodiments filter cartridges with adjustable volume are part of a blood circuit set for extracorporeal blood filtration and/or treatment.

Disclosed herein in some embodiments of the invention are adjustable filter apparatus for changing the volume of the internal chamber of a filter cartridge. In some embodiments of the invention, the adjustable filter apparatus can be used to adjust the filter during filter procedures so that the volume of the internal chamber of the filter cartridge can be changed in accordance with the needs of the user. This allows greater flexibility during procedures. For example, the volume of the filter cartridge internal chamber can be reduced further to more tightly pack the media. This reduction of the filter cartridge internal chamber volume can be used during a filter procedure to, for example, increase filter efficiency. The volume of the internal chamber can be increased during a procedure to, for example, reduce back pressure if needed or to obtain a higher flow rate.

In some embodiments of the invention, the adjustable filter apparatus used for changing the volume of the internal chamber of a filter cartridge can be used to adjust the volume of the internal chamber during use or during periods of maintenance in order to allow obstructions or lodged particles in the fluid pathway to be removed or dislodged. In some embodiments of the invention, the adjustable filter apparatus used for changing the volume of the internal chamber of a filter cartridge can be used to adjust the volume of the internal chamber during periods of maintenance in order to allow for cleaning of the internal chamber or fluid pathways that are typically inaccessible or filled with filtration media during normal use.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1A shows a cross section of an adjustable filter apparatus with fixed tube length and a piston-screw adjuster in a prime state;

FIG. 1B shows a cross-section of filter media in an adjustable filter apparatus in a prime state;

FIG. 1C shows a detail view of a piston-screw adjustor region;

FIG. 2A shows a cross-section of an adjustable filter apparatus with fixed tube length and a piston-screw adjuster in a filter state;

FIG. 2B shows a cross-section of filter media in an adjustable filter apparatus in filter state;

FIG. 3A shows a cross-section of a telescopic adjustable filter cartridge in prime state;

FIG. 3B shows a cross-section of filter media in a telescopic adjustable filter cartridge in prime state;

FIG. 4A shows a cross-section of a telescopic adjustable filter cartridge in filter state;

FIG. 4B shows a cross-section of filter media in a telescopic adjustable filter cartridge in filter state;

FIG. 5A shows a dual cartridge housing with two adjustable filter cartridges in prime state and a hand wheel drive screw adjuster;

FIG. 5B shows an adjustable dual filter apparatus with two adjustable filter cartridges in filter state and a hand wheel drive screw adjuster;

FIG. 6A shows an adjustable dual filter apparatus with two adjustable filter cartridges in prime state and a lever adjuster;

FIG. 6B shows an adjustable dual filter apparatus with two adjustable filter cartridges in filter state and a lever adjuster;

FIG. 7A shows an adjustable dual filter apparatus with two adjustable filter cartridges in prime state with a hand wheel and scissor drive adjuster;

FIG. 7B shows an adjustable dual filter apparatus with two adjustable filter cartridges in filter state with a hand wheel scissor drive adjuster;

FIG. 8A shows a cross-section of an adjustable filter apparatus with a piston-screw adjuster in a prime state without filter media;

FIG. 8B shows a cross-section of a telescopically adjustable filter cartridge in prime state without filter media;

FIG. 9A shows an adjustable dual filter apparatus with two adjustable filter cartridges in prime state in an extracorporeal blood filtration set up that is ready for priming;

FIG. 9B shows an adjustable dual filter apparatus with two adjustable filter cartridges in filter state in an extracorporeal blood filtration set up incorporated into a percutaneous hepatic perfusion procedure;

FIG. 10A shows a cross-section of an adjustable filter apparatus with an elastomeric filter tube in a filter state without filter media;

FIG. 10B shows a cross-section of an adjustable filter apparatus with an elastomeric filter tube expanded axially and in a prime state without filter media; and

FIG. 10C shows a cross-section of an adjustable filter apparatus with an elastomeric filter tube expanded radially and in a prime state without filter media.

Like reference numbers and designations in the various drawings indicate like elements.

### DETAILED DESCRIPTION

The invention is further described with specific reference to the figures (drawings) attached hereto. It is understood, however, that the embodiments described in the figures (drawings) are for the purposes of illustration only and that they are not intended to imply any essential limitation on the scope of the invention. The figures (drawings) may not in all cases be drawn to scale. All materials used are available for purchase from a variety of sources such as Cole Parmer (Vernon Hills, Ill.), McMaster Carr (Elmhurst, Ill.), MSC Industrial Supply Co. (Melville, N.Y.), Grainger (Lake Forest, Ill.), and Qosina (Edgewood, N.Y.), or can be prepared using basic manufacturing methods.

Some embodiments of the invention are directed to an adjustable filter apparatus for removing toxic compounds from biological fluids such as blood and methods for priming a filtration media for use in filtering biological fluids such as blood. Provided herein, in some embodiments of the invention, is an adjustable filter apparatus that solves the problem of trapped gas, or air bubbles, in filter media, by providing one or more filter cartridges having internal chambers of variable volume. The filter cartridges, in accordance with some embodiments of the invention, can be in a prime state, where the volume of the filter cartridge is greater and allows for easy filter priming, and a filter state, where the volume of the filter cartridge is smaller but the ratio of filter media to cartridge volume is such that the filter cartridge will be effective for filtering. This approach is surprising and unexpected because persons of skill in the art directed their filter design efforts towards maintaining a proper ratio of housing volume to filter media volume in filtration procedures. The adjustable filter apparatus disclosed herein provides for savings in time, effort, and resources.

As used herein, the term “prime state” refers to a filter cartridge, or any vessel holding filter media and used as a filter, that has its internal volume, or internal chamber volume, expanded such that the filter priming process is facilitated in accordance with embodiments of the invention.

As used herein, the term “filter state” refers to a filter cartridge, or any vessel holding filter media and used as a filter, wherein the internal chamber volume of the cartridge is such that the cartridge will be effective for filtration. This is the ordinary configuration of a filter as compared with the prime state introduced herein which refers to a configuration wherein the volume in which the filter media resides is larger than in the filter state of ordinary filters. As used herein, “filter media” refers to any material used in filter cartridges in accordance with some embodiments of the invention that would requires priming prior to use.

As used herein, “filter cartridge” refers to a structural unit that holds, or houses, filter media in an internal chamber, the volume of which can be adjusted in accordance with some embodiments of the invention.

As used herein “internal chamber” refers to the region of a filter cartridge that filter media resides in.

As used herein “housing” refers to a structure surrounding or holding one or more filter cartridges.

As used herein, the terms “comprises”, “comprising” and grammatical equivalents thereof mean that other components, ingredients, steps etc. are optionally present. For example, an article “comprising” components A, B, and C can contain, or be made of, components A, B, and C, or it can contain, or be made of, not only components A, B, and C, but also one or more other components. As used herein, the singular forms “a,” “an” and “the” include plural referents unless the context clearly dictates otherwise. Thus, for example, reference to “a cartridge” includes embodiments having one or more such filter cartridge unless the context clearly indicates otherwise.

Reference numbers refer to the figures.

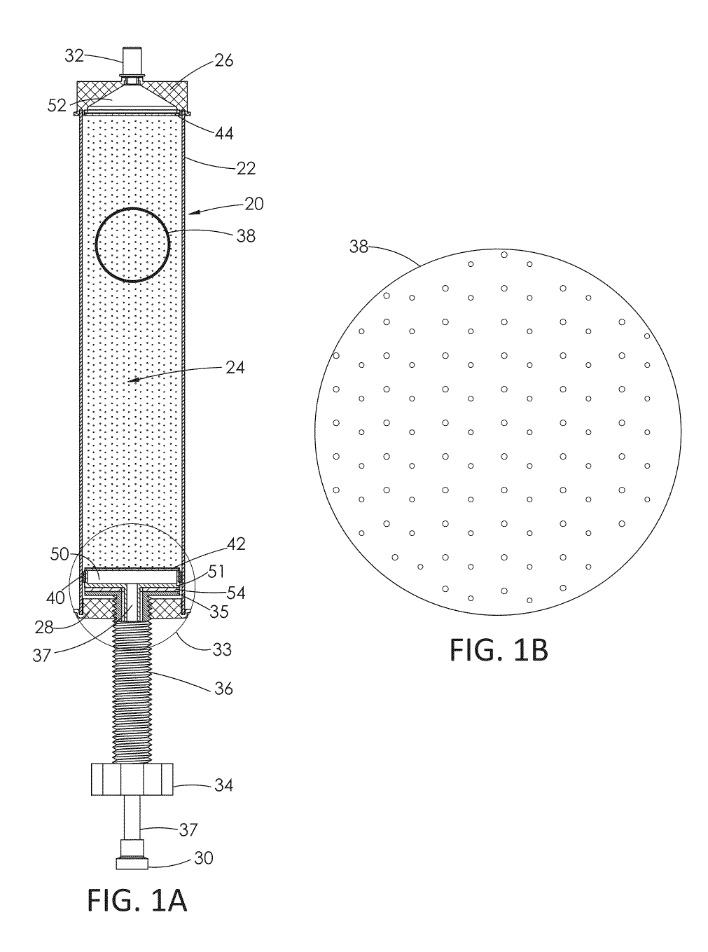

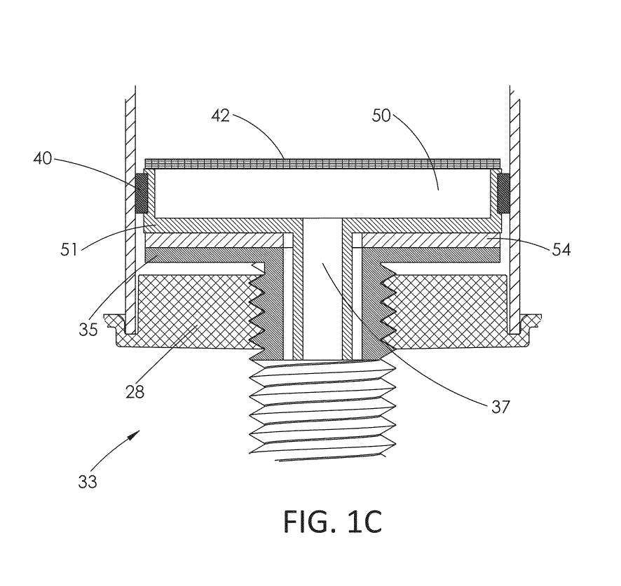

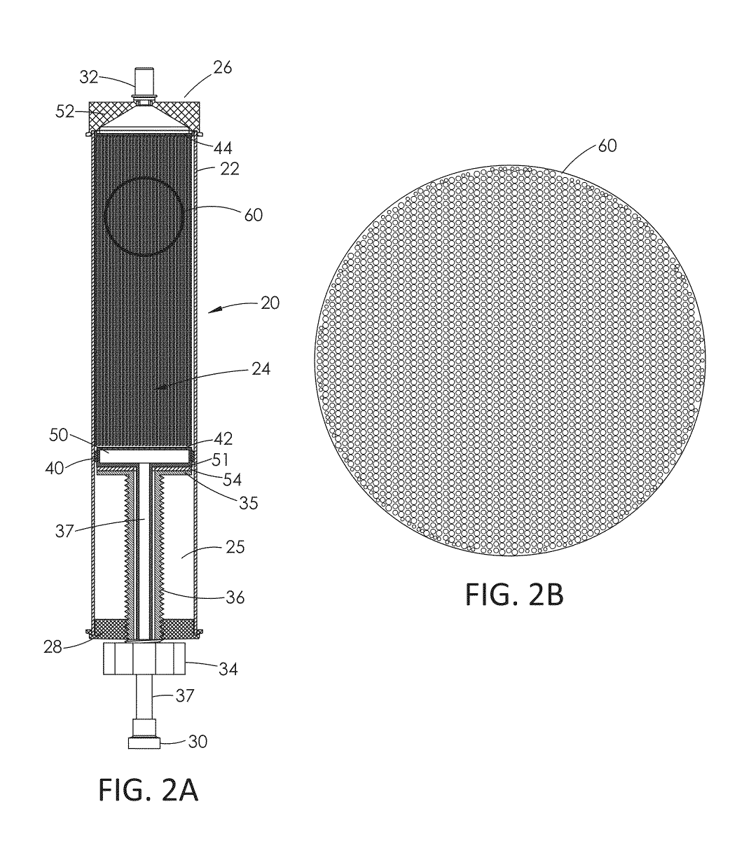

FIG. 1A shows an adjustable filter apparatus 20 in accordance with some embodiments of the invention. The adjustable filter apparatus 20 in FIG. 1A is shown in a prime state as compared to the adjustable filter apparatus 20 shown in FIG. 2A in a filter state. The adjustable filter apparatus shown in FIG. 1A is comprised of a filter cartridge top 26, a filter cartridge bottom 28, a filter cartridge tube 22 that defines an internal chamber 24 which holds filter media 38. In the adjustable filter apparatus 20 an inlet connector 30 is connected to an inlet accumulator 50 through an inlet tubing 37. The inlet connector 30 is fixed to the inlet tubing 37 which is fixed to the inlet accumulator 50. A drive piston knob 34, and a threaded drive piston shaft 36 are connected with a drive piston. The screw adjustor region 33 comprises the filter cartridge bottom 28, a drive piston 35, a thrust washer 54, an inlet accumulator body 51, an inlet accumulator 50, a seal 40, and an inlet mesh screen 42 that separates the inlet accumulator 50 from the internal chamber 24. An outlet connector 32 is connected to the filter cartridge top 26, and the lower surface of which is separated from the filter chamber 24 by an outlet mesh screen 44 which is fixed to the filter cartridge top and resides between the outlet accumulator 52 and the internal chamber 24. The outlet accumulator 52 is represented as free space under the filter cartridge top.

The threaded drive piston shaft 36 is connected to the drive piston 35 and is operably linked to the drive piston knob 34 such that when the drive piston knob 34 is rotated, the threaded drive piston shaft 36 engages female threads in the filter cartridge bottom 28 and the drive piston 35, thrust washer 54, inlet accumulator body 51, and inlet mesh screen 42 of the piston screw adjustor region 33 can be moved through the internal chamber 24. A seal 40 between the inlet accumulator body 51 and the inner wall of the filter cartridge tube 22 prevents leakage of air or filter priming solution. In this way the volume of the internal chamber 24, in some embodiments of the invention can be changed from a prime state, for priming the filter, to a filter state, suitable for filtration procedures.

In FIG. 1A, the adjustable filter apparatus 20 is in prime state and the filter media 38 is shown as being loosely packed with individual particles of the media free to move. FIG. 1B is a detail view of the filter media 38 in the prime state and should be compared with the filter media 60 in the filter state 60 as shown in FIG. 2B.

FIG. 1C is a detail view of the piston screw adjuster region 33, the filter cartridge bottom 28 is connected via internal threading to the drive piston which is in contact with the inlet accumulator body 51 through a thrust washer 54. The moveable unit of the piston screw adjustor region, the drive piston 35, inlet accumulator body 51, and inlet mesh screen 42, is sealed against the inner wall of the filter cartridge tube by a seal 40.

FIG. 2A shows an adjustable filter apparatus 20 in accordance with some embodiments of the invention and is the same adjustable filter apparatus as in FIG. 1A except that it is in filter state. In FIG. 2A the drive piston 35, thrust washer 54, inlet accumulator body 51, and inlet mesh screen 42 of the piston screw adjustor region 33 has been advanced into the internal chamber 24 as compared with FIG. 1A such that the adjustable filter apparatus 20 as depicted in FIG. 2A is in a filter state. In the filter state, the filter media 60 is depicted as much more closely packed in the ordinary packing of filter media for filtration that has caused problems when priming.

The adjustable filter apparatus shown in FIG. 2A is comprised of a filter cartridge top 26, a filter cartridge bottom 28, a filter cartridge tube 22 that defines an internal chamber 24 which holds filter media 38. In the adjustable filter apparatus 20 an inlet connector 30 is connected to an inlet accumulator 50 through an inlet tubing 37. The inlet connector 30 is fixed to the inlet tubing 37 which is fixed to the inlet accumulator 50. A drive piston knob 34, and a threaded drive piston shaft 36 are connected with a drive piston. The screw adjustor region 33 comprises the filter cartridge bottom 28, a drive piston 35, a thrust washer 54, an inlet accumulator body 51 an inlet accumulator 50, a seal 40, and an inlet mesh screen 42 that separates the inlet accumulator 50 from the internal chamber 24. An outlet connector 32 is connected to the filter cartridge top 26, and the lower surface of which is separated from the filter chamber 24 by an outlet mesh screen 44 which is fixed to the filter cartridge top and resides between the outlet accumulator 52 and the internal chamber 24. The outlet accumulator 52 is represented as free space under the filter cartridge top.

The threaded drive piston shaft 36 is connected to the drive piston 35 and is operably linked to the drive piston knob 34 such that when the drive piston knob 34 is rotated, the threaded drive piston shaft 36 engages female threads in the filter cartridge bottom 28 and the drive piston 35, thrust washer 54, inlet accumulator body 51, and inlet mesh screen 42 of the piston screw adjustor region 33 can be moved through the internal chamber 24. A seal 40 between the inlet accumulator body 51 and the inner wall of the filter cartridge tube 22 prevents leakage of air or filter priming solution. In this way the volume of the internal chamber 24, in some embodiments of the invention can be changed from a prime state, for priming the filter, to a filter state, suitable for filtration procedures.

In FIG. 2A the drive piston 35 has been advanced into the internal chamber of the filter cartridge tube 22 decreasing the volume in which the filter media is free to move leaving a much more closely packed filter media 60 than the filter media 38 as shown in FIG. 1A.

While the adjustable filter apparatus 20 as shown in FIG. 1A and FIG. 2A depicts the region surrounding the internal chamber 24 as a cylindrical tube with a flat bottom and a flat top, a variety of other geometrical shapes are encompassed by some embodiments of the invention. For example, the region above the accumulator 52 could be conical and the filter cartridge tube 22 could, in some embodiments, be other geometrical shapes than cylindrical.

In some embodiments of the invention, an adjustable filter apparatus with filter media can be provided in a prime state. After priming, a user can adjust the internal chamber 24 volume to a volume suitable for filtration. In some embodiments of the invention the adjustable filter apparatus 20 can be provided to a user without filtration media allowing the user the flexibility to use the adjustable filter apparatus for filtration media and needs of their choosing.

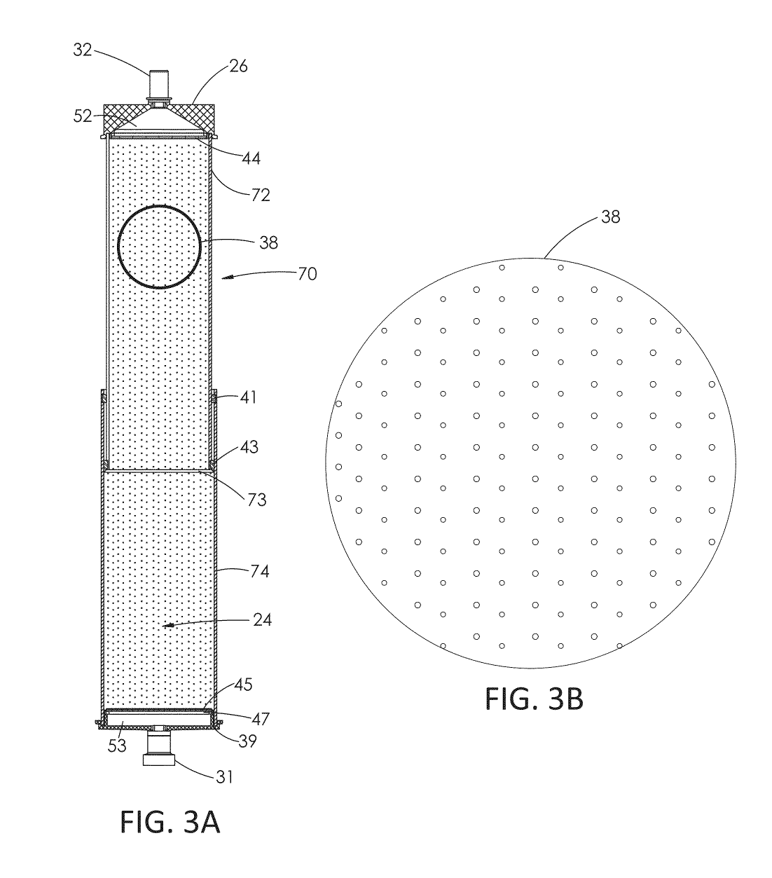

FIG. 3A shows a telescopic adjustable filter cartridge 70 in a prime state. A telescopic adjustable filter cartridge 70, in accordance with some embodiments of the invention, is comprised of an inner cartridge tube 72, an outer cartridge tube 74, an internal chamber 24 formed from the inner cartridge tube 72 and the outer cartridge tube 74. The telescopic adjustable filter cartridge 70 has an inlet connector 31 in the cartridge bottom 39, the inlet connector 31 is connected with an inlet accumulator 53. On top of the inlet accumulator 53, and facing the internal chamber 24, is a mesh screen support 47, which attaches to the inlet mesh screen 45 which is in contact with the internal chamber 24, an outer tube seal 43 resides in a groove on the inner cartridge tube 72 and seals against the outer cartridge tube 74, and an inner tube seal 41, resides in a groove on the outer cartridge tube 74, and seals against the inner cartridge tube 72. At the top of the telescopic adjustable filter cartridge 70 is a filter cartridge top 26 with an outlet connector 32 disposed within the filter cartridge top 26, the outlet connector 32 is connected such that fluid can flow to an outlet accumulator 52, a free space, and separated from the internal chamber 24 by an outlet mesh screen 44 which is fixed to the cartridge to 26 and is in contact with the internal chamber 24.

In FIG. 3A, the telescopic adjustable filter cartridge 70 is in a prime state and the filter media 38 is shown as being loosely packed with individual particles of the media free to move.

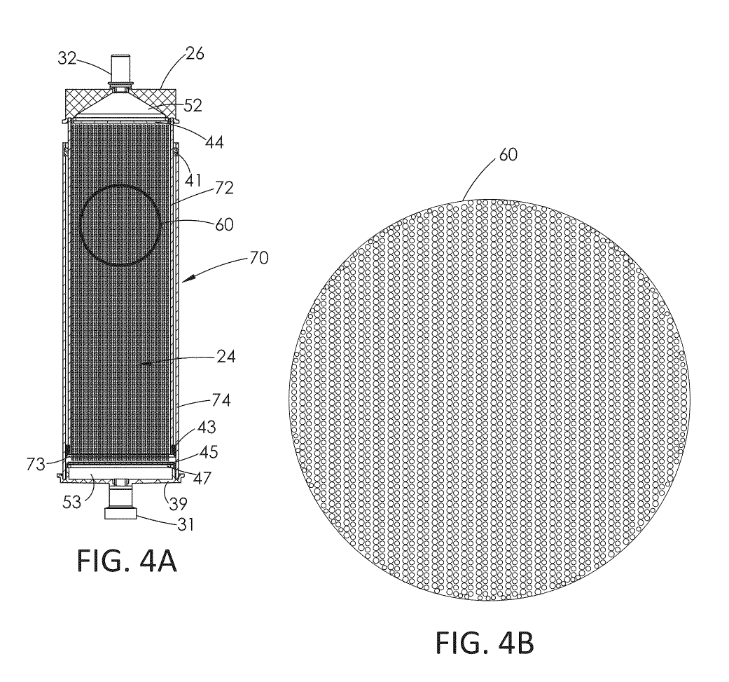

FIG. 3B is a detail view of the filter media 38 in the prime state and should be compared with the filter media 60 in the filter state as shown in FIG. 4B, a detail view of the filter media 60 as in the telescopic adjustable filter cartridge 70 shown in FIG. 3B in a filter state.

FIG. 4A shows a telescopic adjustable filter cartridge 70, in accordance with some embodiments of the invention, in a filter state and is the same as the telescopic adjustable filter cartridge as shown in FIG. 3A except that an internal chamber 24 volume is appropriate for filtering due to its closer packing of the same quantity of filter media as in the telescopic adjustable filter cartridge shown in FIG. 3A. The telescopic adjustable filter cartridge 70 is comprised of an inner cartridge tube 72, an outer cartridge tube 74, and an internal chamber 24 formed from the inner cartridge tube 72 and the outer cartridge tube 74 but here, the telescopic adjustable filter cartridge 70 in a filter state has the inner cartridge tube 72 extended into the outer cartridge tube 74 to reduce the volume of the internal chamber 24 and provide the filter state.

The telescopic adjustable filter cartridge 70, in FIG. 4A, has an inlet connector 31 in the cartridge bottom 39, the inlet connector 31 is connected with an inlet accumulator 53. On top of the inlet accumulator 53, and facing the internal chamber 24, is a mesh screen support 47, which attaches to the inlet mesh screen 45 which is in contact with the internal chamber 24, an outer tube seal 43 resides in a groove on the inner cartridge tube 72 and seals against the outer cartridge tube 74, and an inner tube seal 41, resides in a groove on the outer cartridge tube 74, and seals against the inner cartridge tube 72. At the top of the telescopic adjustable filter cartridge 70 is a filter cartridge top 26 with an outlet connector 32 disposed within the filter cartridge top 26, the outlet connector 32 is connected such that fluid can flow to an outlet accumulator 52, a free space, and separated from the internal chamber 24 by an outlet mesh screen 44 which is fixed to the cartridge to 26 and is in contact with the internal chamber 24.

FIG. 4A the telescopic adjustable filter cartridge 70 is in a filter state and the filter media 60 is shown in the more dense filter state. The filter media 60 in the filter state is depicted in FIG. 4B in a detail view as being more dense than in FIG. 3B, the prime state.

While the telescopic adjustable filter cartridge 70 shown in FIG. 3A and FIG. 4A depicts the region surrounding the internal chamber 24 as a cylindrical tube with a flat bottom and a flat top, a variety of other geometrical shapes are encompassed by some embodiments of the invention. For example, the region above the accumulator 52 could be conical and the filter cartridge tubes 72 and 74 could, in some embodiments of the invention, be other geometrical shapes than cylindrical.

In FIGS. 1A, 2A, 3A, and 4A, the comparison between prime states and filter states for these different embodiments of the invention where filter media is shown as both loosely packed (the prime state) and densely packed (the filter state) it should be understood that the comparisons between the prime state and filter state of these embodiments of the invention refer to a similar amount of filter media on comparing FIG. 1A and FIG. 1B with FIG. 2A and FIG. 2B, and in on comparing FIG. 3A and FIG. 3B with FIG. 4A and FIG. 4B.

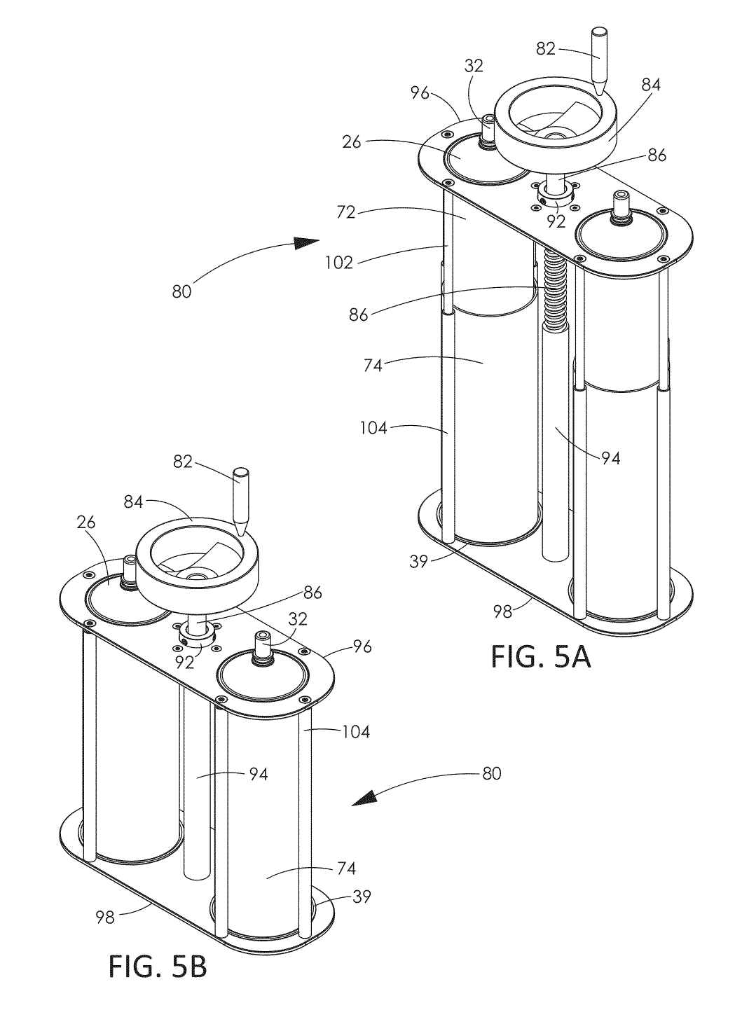

FIGS. 5, 6, and 7 describe adjustable dual filter apparatus that can be used with some embodiments of the invention. These adjustable dual filter apparatus and the combination with filter cartridges can also be described as filter assemblies. Housings, in these embodiments of the invention, refer to the structure that surrounds or holds one or more filter cartridges. The adjustable dual filter apparatus described herein comprise two adjustable telescopic adjustable filter cartridges, in accordance with some embodiments of the invention. Other filter housings than those described herein can be used for changing the internal chamber volume of one or more filter cartridges in accordance with the principles of the invention. It is understood that other telescopic adjustable filter cartridges could be used with other adjustable dual filter apparatus in some embodiments of the invention and that the adjustable dual filter apparatus and the telescopically adjustable filter cartridges in this and the other figures are not to be taken as limiting the scope of the disclosure. In addition, filter apparatus, and/or housings that can be used with one or more adjustable filter apparatus in accordance with the adjustable filter apparatus described in FIG. 1A and FIG. 2A are within the scope of this disclosure. Any combination that includes means for changing the volume of the internal chamber of a filter cartridge, or filter, is contemplated by this disclosure if it can be used in the filter priming process in accordance with the broad principles described herein.

FIG. 5A and FIG. 5B show an adjustable dual filter apparatus with screw drive 80, with telescopic filter cartridges, in accordance with some embodiments of the invention. Within the adjustable housing 80 are two telescopic filter cartridges such as the cartridge shown in FIG. 3A and FIG. 4A. The adjustable dual filter housing apparatus with screw drive 80 enables the changing of telescopic filter cartridges between a prime state and a filter state and can be used with the telescopic filter cartridge 70, or other telescopic filter cartridges. In the description in this embodiment of the invention, and for the other dual filter housing apparatus described herein, we will use the telescopic filter cartridge 70 of FIG. 3A and FIG. 4A as illustrative.

FIG. 5A shows the adjustable dual filter apparatus with screw drive 80 in a position holding two telescopic filter cartridges in a prime state. In FIG. 5A an inner cartridge tube 72 is shown inserted into the outer cartridge tube 74. FIG. 5B shows the adjustable dual filter apparatus with screw drive 80 holding two telescopic filter cartridges in the filter state, where the inner cartridge tube 72 has been extended all the way into the outer cartridge tube 74 and the inner cartridge tube 72 is no longer visible.

The adjustable dual filter apparatus with screw drive 80 in FIG. 5A and FIG. 5B has a hand wheel knob 82 attached to a hand wheel 84, which is attached to a drive screw 86 within a bearing 92. The inner ring of the bearing (not visible) is attached to the drive screw 86. The bearing housing (not shown) is attached to the upper plate 96. The bottom of a female screw receiver 94 is attached to a lower plate 98. In the adjustable dual filter apparatus with screw drive 80, the drive screw 86 is received by the female thread screw receiver 94. The adjustable dual filter apparatus with screw drive 80 has an upper plate 96 and a lower plate 98 and inner support rods 102 and outer support rods 104 attached to the upper plate 96 and lower plate 98 respectively. The cartridge top 26 and cartridge bottom 39 are attached to the upper plate 96 and lower plate 98 respectively. In FIG. 5A the telescopic filter cartridge 70 visible parts are the outlet connector 32, cartridge top 26, cartridge bottom 39, the inner cartridge tube 72, and the outer cartridge tube 74. The inner cartridge tube 72 is extended out of the outer cartridge tube with the telescopic filter cartridge 70 in the prime state. In FIG. 5B, the inner cartridge tube 72 is not visible since it is extended into the outer cartridge tube 74, with the telescopic filter cartridge 70 in the filter state. Rotating the hand wheel 84 engages the threads on the drive screw 86 and female thread screw receiver 94 causing the upper plate 96 and the lower plate 98 to move towards or away from each other depending on the direction of rotation. This movement causes the inner cartridge tube 72 to extend into or out of the outer cartridge tube 74 depending on the direction of rotation, thus increasing or decreasing the internal chamber 24 volume depending on the direction of rotation.

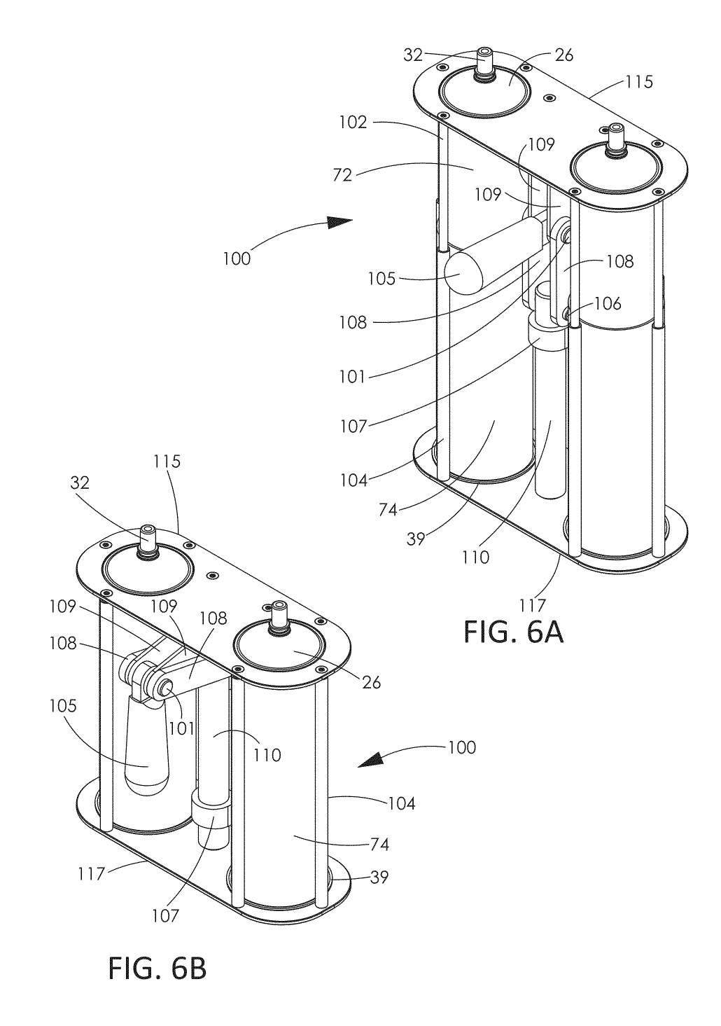

FIG. 6A and FIG. 6B show an adjustable dual filter apparatus with lever drive 100, with telescopic filter cartridges, in accordance with some embodiments of the invention. Within the adjustable filter apparatus with lever drive 100 are two telescopic filter cartridges such as the cartridge shown in FIG. 3A and FIG. 4A. FIG. 6A shows the adjustable dual filter apparatus with lever drive 100 with the telescopic cartridges in a prime state and FIG. 6B shows the adjustable dual filter apparatus with lever drive 100 with the telescopic cartridges in the filter state.

FIG. 6A shows the adjustable dual filter apparatus with lever drive 100 in a position holding two telescopic filter cartridges in a prime state. In FIG. 6A inner cartridge tube 72 is shown inserted into outer cartridge tube 74. FIG. 6B shows the adjustable dual filter apparatus with lever drive 100 holding two telescopic filter cartridges in a filter state, where the inner cartridge tube 72 has been extended all the way into the outer cartridge tube 74 and the inner cartridge tube 72 is no longer visible.

The adjustable dual filter apparatus with lever drive 100 in FIG. 6A and FIG. 6B has a lever handle 105 connected to an inner linkage 109 which connects to an outer linkage 108 operably connected to a lever shaft 110 by the outer linkage through an upper pivot joint 101 and a lower pivot joint 106, the lever shaft supported by a guide bushing 107 which connects to the lever base (not shown). The lever base (not shown) is attached to the upper plate 115 and the bottom of the lever shaft 110 is attached to the lower plate 117.

The adjustable dual filter apparatus with lever drive 100 has an upper plate 115 and a lower plate 117 and inner support rods 102 and outer support rods 104 attached to the upper plate 115 and lower plate 117 respectively. The cartridge top 26 and the cartridge bottom 39 are attached to the upper plate 115 and the lower plate 117 respectively. In FIG. 6A the telescopic filter cartridge 70 visible parts are the outlet connector 32, cartridge top 26, cartridge bottom 39, the inner cartridge tube 72, and the outer cartridge tube 74. The inner cartridge tube 72 is extended out of the outer cartridge tube with the telescopic filter cartridge 70 in a prime state. In FIG. 6B, the inner cartridge tube 72 is not visible since it is extended into the outer cartridge tube 74, with the telescopic filter cartridge 70 in the filter state. Pushing or pulling the lever handle 105 engages the lever mechanism and causes the lever linkages to extend and retract respectively, in turn causing the upper plate 115 and lower plate 117 to move towards each other when the lever is retracted or away from each other when the lever is extended. This movement causes the inner cartridge tube 72 to extend into or out of the outer cartridge tube 74 depending on whether the lever is retracted or extended, thus increasing or decreasing the internal chamber 24 volume depending on the position of the lever.

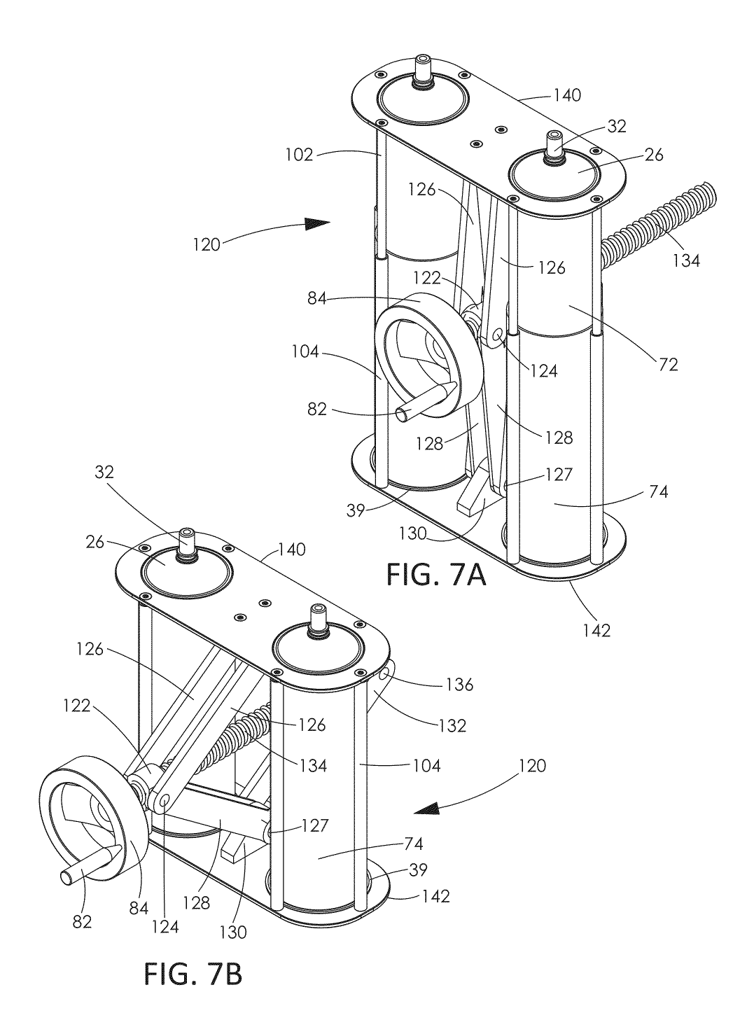

FIG. 7A and FIG. 7B show an adjustable dual filter apparatus with scissor drive 120, with telescopic filter cartridges, in accordance with some embodiments of the invention. Within the adjustable filter apparatus with scissor drive 120 are two telescopic filter cartridges such as the cartridge shown in FIG. 3A and FIG. 4A. The adjustable dual filter apparatus with scissor drive 120 enables the changing of telescopic filter cartridges between a prime state and a filter state and can be used with the telescopic filter cartridge 70, or other telescopic filter cartridges.

FIG. 7A shows the adjustable dual filter apparatus with scissor drive 120 in a position holding two telescopic filter cartridges in a prime state. In FIG. 7A an inner cartridge tube 72 is shown inserted into the outer cartridge tube 74. FIG. 7B shows the adjustable dual filter apparatus with scissor drive 120 holding two telescopic filter cartridges in the filter state, where the inner cartridge tube 72 has been extended all the way into the outer cartridge tube 74 and the inner cartridge tube 72 is no longer visible.

The adjustable dual filter apparatus with scissor drive 120 in FIG. 7A and FIG. 7B has a hand wheel knob 82 attached to a hand wheel 84, which is attached to a drive screw 134 within a bearing 122. The inner ring of the bearing 122 is attached to the drive screw 134. The bearing housing is attached a bearing end pivot joint 124. The adjustable dual filter apparatus with scissor drive 120 has the bearing 122 connected to the front inner linkage 128 and bearing pivot joint 124 connecting and actuating a front outer linkage 126 and the front inner linkage 128. A nut (not shown) is connected to the back inner linkage (not shown) and nut end pivot joint 136 connecting and actuating a back inner linkage (not shown) and a back outer linkage 132. A pivot joint 127 connects a pivot block 130 to a back outer linkage 132 and a front inner linkage 128. The pivot block 130 is attached to lower plate 142. Another pivot block 130 is attached to upper plate 140. This pivot block 130 is attached to another pivot joint 127 which connects the front outer linkage 126 and back inner linkage (not shown).

The adjustable dual filter apparatus with scissor drive 120 has an upper plate 140 and a lower plate 142 and inner support rods 102 and outer support rods 104 attached to the upper plate 140 and lower plate 142 respectively. The cartridge top 26 and the cartridge bottom 39 are attached to the upper plate 140 and lower plate 142 respectively. In FIG. 7A the telescopic filter cartridge 70 visible parts are the outlet connector 32, cartridge top 26, the cartridge bottom 39, the inner cartridge tube 72, and the outer cartridge tube 74. The inner cartridge tube 72 is extended out of the outer cartridge tube 74 with the telescopic filter cartridge in the prime state. In FIG. 7B, the inner cartridge tube 72 is not visible since it is extended into the outer cartridge tube 74, with the telescopic filter cartridge 70 in the filter state. Rotating the hand wheel 84 engages the threads on the drive screw 134 and nut (not shown) causing the nut end pivot joint 136 and bearing end pivot joint 124 to move towards or away from each other depending on the direction of rotation. With the ends of the linkages constrained at the pivot joints 127, the linkages are forced to extend or retract depending on the direction of rotation. This causes the upper plate 140 and lower plate 142 to move towards or away from each other depending on the direction of rotation. This movement causes the inner cartridge tube 72 to extend into or out of the outer cartridge tube 74 depending on the direction of rotation, thus increasing or decreasing the internal chamber 24 volume depending on the direction of rotation.

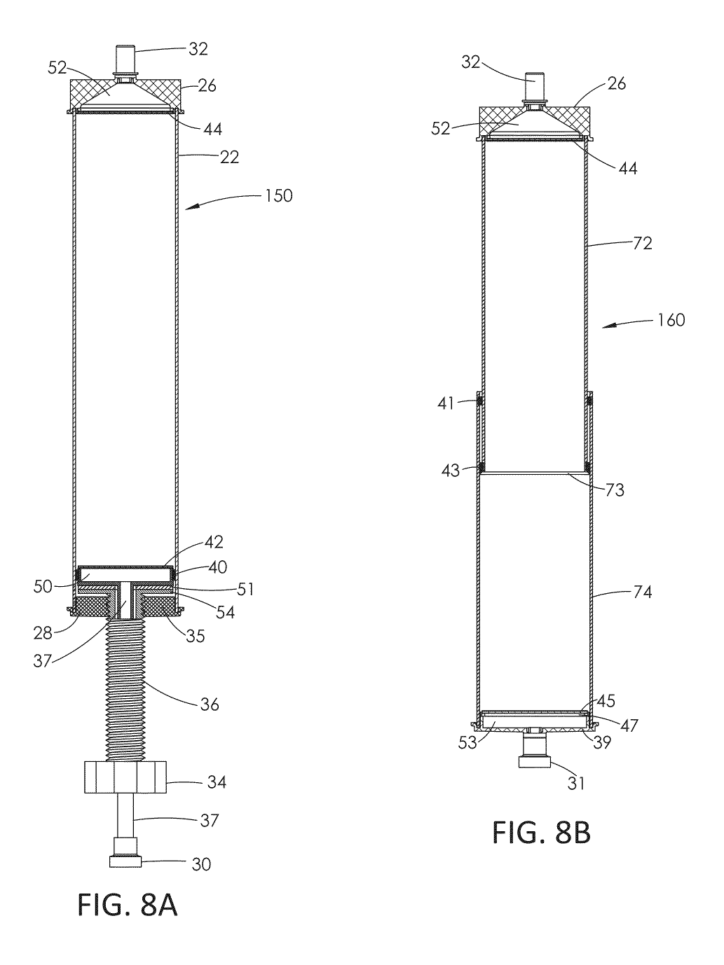

FIG. 8A and FIG. 8B show an adjustable filter apparatus 150 and a telescopic filter cartridge 160 without filter media in accordance with some embodiments of the invention. The filter apparatus and filter cartridges disclosed herein can be provided without filter media such that a user can introduce filter media of their choice.

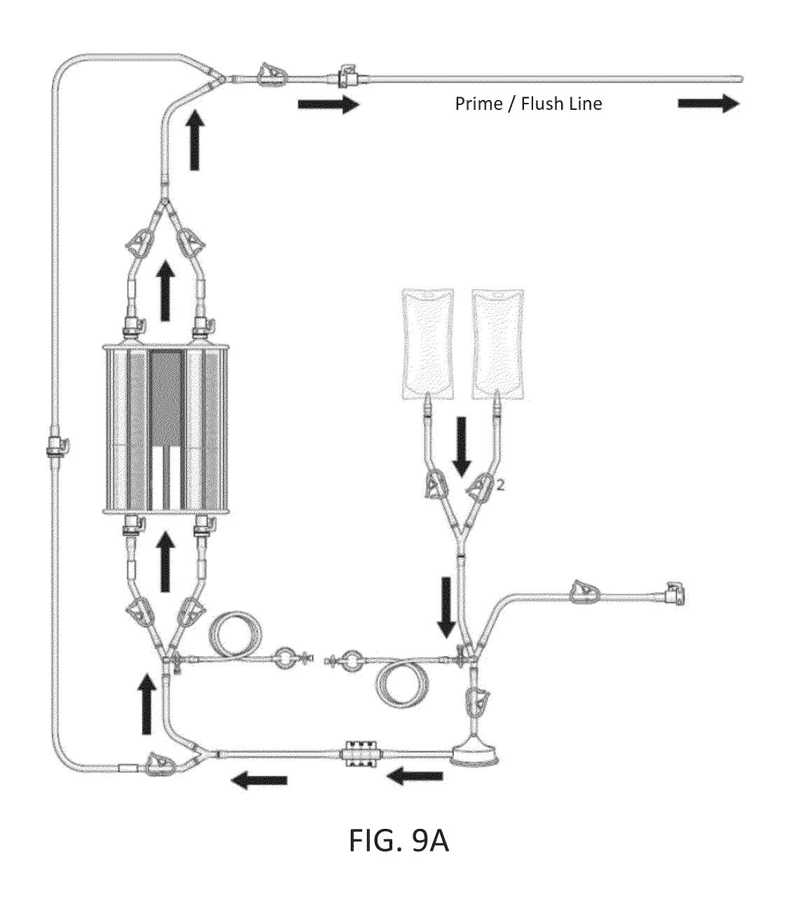

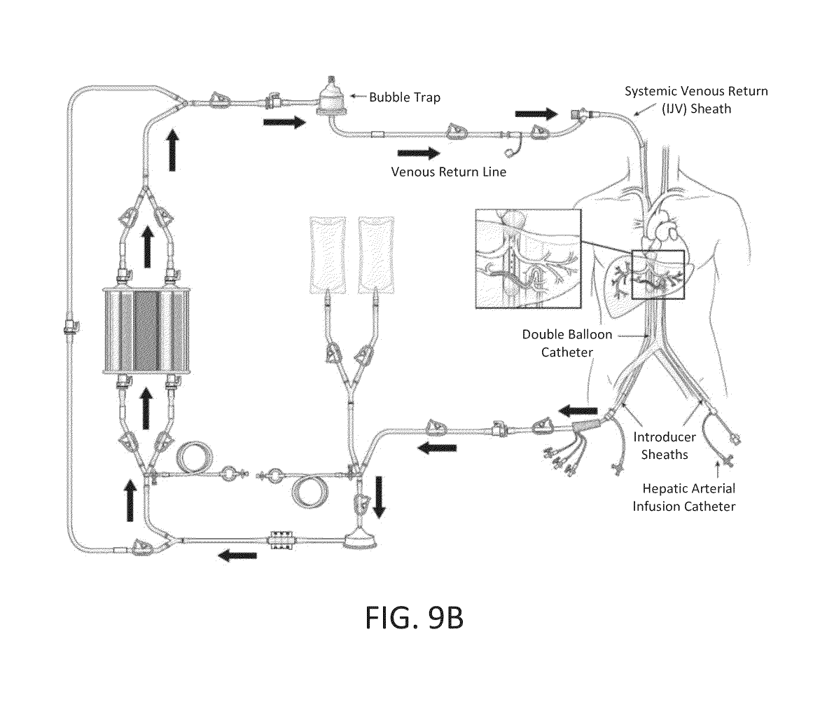

FIG. 9A and FIG. 9B show an adjustable dual filter apparatus in the context of its application in an extracorporeal blood filtration in an isolated organ chemotherapy treatment. Shown in FIG. 9A are the filter cartridges in a prime state for filter priming. In FIG. 9B the filter cartridges of the adjustable dual filter apparatus are shown in filter state and are ready to filter blood. This is an example of how the filter apparatus and priming methods described in some embodiments of the invention can be used. In this example, the extracorporeal filters are used to remove chemotherapeutic drugs from the blood stream during cancer treatments such as in hepatic chemosaturation therapy. This therapy also known as percutaneous hepatic perfusion (PHP) procedure delivers ultra-high doses of intra-arterial chemotherapy directly into the isolated liver, saturating both the liver and the tumor cells. The blood from the liver is drained through an isolation-aspiration catheter, and then directed outside the body to proprietary filters, which reduce the concentration of chemotherapeutic agent before this blood is returned to the body. The potential of chemosaturation therapy includes: the ability to administer higher doses of chemotherapeutic agent to a particular organ than could be delivered with traditional systemic-intravenous methods while significantly reducing systemic exposure to the high dose levels.

In this example, where the filters used to absorb the drug from the blood are incorporated in an extracorporeal circuit, the blood drained from the liver through the isolation aspiration catheter is pumped by a venous bypass pump, such as is used in heart bypass surgery, through a filter or set of filters. The outlet of the filter(s) is connected by a tube set to a return catheter inserted in a central vein, through which the cleaned blood is returned to the patient's circulatory system. The filter(s) absorb drug at an efficiency which protects the patient's systemic circulation from toxic side effects of high dose drug concentrations. During use with certain drugs such as Melphalan Hydrochloride, poor filtration can cause side effects such as anemia, thrombocytopenia, neutropenia, together commonly known as Myelo Suppression can occur. Other drugs at high concentrations have risk of cardio toxicities if poor filtration fails to reduce systemic concentrations to safe levels.

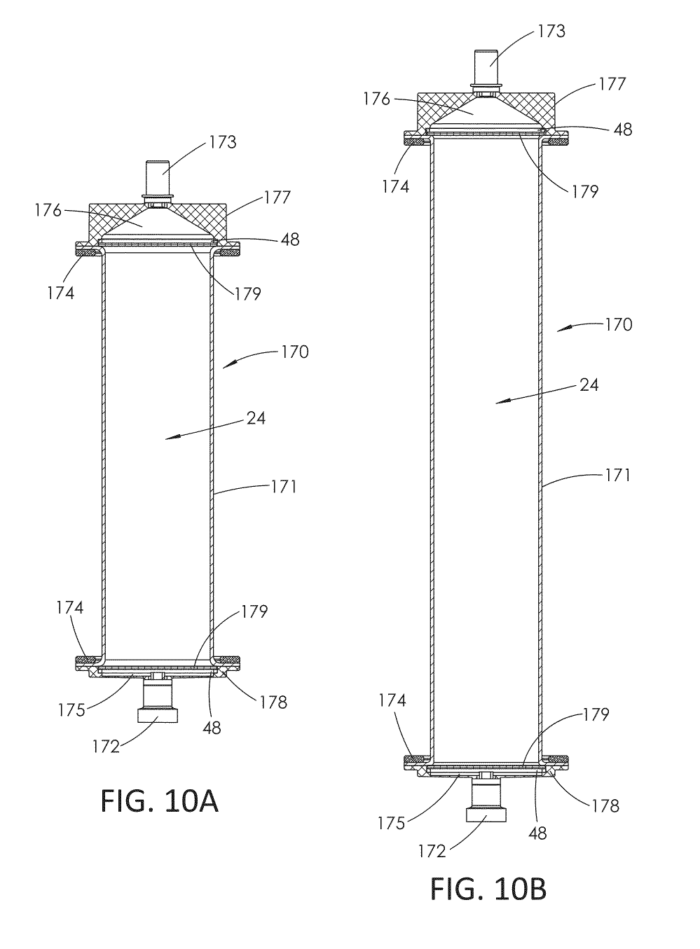

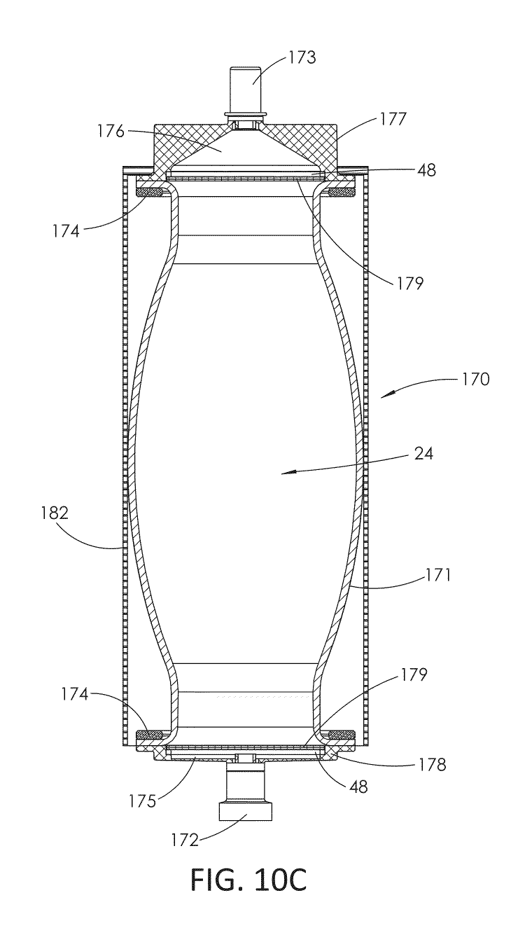

FIG. 10A, FIG. 10B and FIG. 10C show an elastomeric adjustable filter cartridge 170 without filter media in accordance with some embodiments of the invention. The filter apparatus and filter cartridges described herein can be provided without filter media such that a user can introduce filter media of their choice. The elastomeric adjustable filter cartridge 170 in FIG. 10A is shown in a filter state as compared to the elastomeric adjustable filter cartridge 170 shown in FIG. 10B and FIG. 10C shown in a prime state. The elastomeric adjustable filter cartridge 170, in FIG. 10A, FIG. 10B and FIG. 10C, has an inlet connector 172 in the cartridge bottom 178, the inlet connector 172 is connected with an inlet accumulator 175. On top of the inlet accumulator 175, and facing the internal chamber 24, is a mesh screen support 48, which attaches to the mesh screen 179 which is in contact with the internal chamber 24. The flanges on the elastomeric filter cartridge tube 171 are compressed and sealed between the sealing clamp 174 and the filter cartridge bottom 178 on the inlet side and the sealing clamp 174 and filter cartridge top 177 on the outlet side. This compression may be achieved by means of a series of bolts, chemical bonds, insert molding or any other method that will ensure compression of the flange on the filter cartridge tube 171 between the sealing clamp 174 and the filter cartridge bottom 178 and filter cartridge top 177. At the top of the elastomeric adjustable filter cartridge 170 is a filter cartridge top 177 with an outlet connector 173 located within the filter cartridge top 177, the outlet connector 173 is connected such that fluid can flow to an outlet accumulator 176, a free space, and separated from the internal chamber 24 by a mesh screen 179 which is fixed to the mesh screen support 48 and attached to the filter cartridge top 177 and is in contact with the internal chamber 24. In some embodiments, as the inlet and outlet ends of the elastomeric adjustable filter cartridge 170 are pulled apart from the filter state, the elastomeric filter cartridge tube 171 stretches and increases the volume of the internal chamber 24. In this way the volume of the internal chamber 24, in some embodiments of the invention, can be changed from a prime state, for priming the filter, to a filter state, suitable for filtration procedures.

In some embodiments, a housing or other structure can be used to pull apart the inlets and outlet ends of the elastomeric adjustable filter cartridge 170 thus stretching the elastomeric filter cartridge tube 171 and increasing the volume of the internal chamber 24. In some embodiments, the internal pressure in the internal chamber 24 exerts enough force on the walls of the elastomeric filter cartridge tube 171 that the tube inflates radially and increases the volume of the internal chamber 24. In this way the volume of the internal chamber 24, in some embodiments of the invention can be changed from a prime state, for priming the filter, to a filter state, suitable for filtration procedures. In some embodiments, a rigid expansion sleeve 182 can be placed over the elastomeric filter cartridge tube 171 such that the expansion of the elastomeric filter cartridge tube 171 is restricted to a size that allows for a volume sufficient for priming, but restricts the elastomeric filter cartridge tube 171 from expanding to a point where it could rupture.

In FIG. 10A the elastomeric adjustable filter cartridge 170 is in a filter state with the elastomeric filter cartridge tube 171 in a relaxed state (recovered) and the volume of the internal chamber 24 appropriate for filtering. In FIG. 10B the elastomeric adjustable filter cartridge 170 is in a prime state with the elastomeric filter cartridge tube 171 in a stretched state and the volume of the internal chamber 24 appropriate for priming. In FIG. 10C the elastomeric adjustable filter cartridge 170 is in a prime state with the elastomeric filter cartridge tube 171 in an expanded state and the volume of the internal chamber 24 appropriate for priming.

While the elastomeric adjustable filter cartridge 170 shown in FIG. 10A, FIG. 10B, and FIG. 10C depicts the region surrounding the internal chamber 24 as a cylindrical tube with a flat bottom and a flat top, a variety of other geometrical shapes are encompassed by some embodiments of the invention. For example, the region above the accumulator 176 could be conical and the filter cartridge tube 171 could, in some embodiments of the invention, be other geometrical shapes than cylindrical.

The filter cartridge tube can be of a material suitable for the application provided that it can be molded or formed into a suitable form and is appropriate for a particular application. In some embodiments the filter cartridge tube and filter cartridge top and bottom are made of a biologically compatible material. For example, the filter cartridge tube, filter cartridge top, and filter cartridge bottom can be made of a polycarbonate, a polysulfone, an acrylic, and the like. The filter cartridge tube may also be made from an elastomer such as a thermoplastic urethane, thermoplastic elastomer, rubbers, or silicones. Where the filter apparatus will be used for blood filtration the filter cartridge tube and filter cartridge top and bottom should be made of a hemo-compatible material such as thermoplastics, thermosetting plastics, elastomers or thermoplastic elastomers. Such plastics include, for example, polycarbonates, polysulfones, acrylic, polyethylene, polypropylene, polyester, nylon, polycarbonate, urethane, silicone and the like. The material may be transparent or opaque, although materials that are at least partially transparent offer some advantages in that the purging of bubbles from the filter media can be easily visualized. Thermoplastic elastomers should be able to withstand 50% elongation with nearly full recovery (return to original shape). In some embodiments, the wall thickness of the elastomeric filter cartridge tube should be thick enough to provide adequate strength to prevent inflation of the elastomeric filter cartridge tube during use, but not so thick in as to prevent the ability to stretch the elastomeric filter cartridge tube in order to provide useful volume for the priming step. In some embodiments, the wall thickness of the elastomeric filter cartridge should be of an appropriate thickness to allow for inflation of the filter cartridge tube under pressurization during the priming step, and then deflation and in normal non-inflated state for the filter step.

To maximize a filter's ability to capture and retain drug, a proper ratio of filter cartridge internal chamber volume to filter media volume is used. Filter media, for example, in the form of spheres or granules coated with a thin layer of hydrogel material which swells slightly when wetted can be used. Such filter media can have spheres or granules of a range of different sizes. In some embodiments, the spheres or granules are comprised of activated carbon and are between about 0.2 mm (200 microns) and about 1.5 mm (1500 microns) in particle size. This is a typical range for activated carbon spheres. In some embodiments, the spheres or granules are comprised of activated carbon and are between about 0.2 mm (200 microns) and about 1 mm (1000 microns) in particle size. Other filter media will have small or larger sizes. In other embodiments larger or smaller spheres or granules can be used. In some embodimentsin the range of 200 micron to 1000 micron may be used. The hydrogel layer can be from about 0.5 to about 2.0 micron thick and protects the blood from clotting as it comes into contact with the filter media but allows for drug molecules to pass through to the absorption media. In these embodiments of the invention, the filter cartridge, when in filter state, should have volume to allow for filter media to hydrate which causes slight swelling and to allow blood to flow through small intermediate space between filter media particles. Before the invention disclosed herein, the practitioner would need to consider having enough space to allow for filter priming but not so much space such that the filter media would “percolate” or move within the internal chamber of the filter cartridge, while other filter media is stagnant, or removed from the flow path, leading to ineffective filtration. In some embodiments of the invention, as described herein, the filter priming process can be carried out by expanding the internal chamber volume of a filter cartridge for filter priming to produce a prime state and then reducing the volume of the internal chamber of the filter cartridge to a volume of internal chamber to filter media ratio that will lead to effective filtration.

In some embodiments, priming fluid is slowly introduced into the internal chamber of the filter cartridge to allow the media to slowly hydrate. This slow introduction takes place while the filter cartridge is in a prime state. Hydrating the media can take time. The time will depend upon the media and hydrogel and can take up to about 30 minutes. Once hydrated and primed the filter can then be flushed and changed to a filter state and efficient filtration can be achieved.

In some embodiments of the invention, the filter apparatus disclosed herein is used with a percutaneous hepatic perfusion (PHP) system for use in the arterial delivery of a small molecule chemotherapy agent such as melphalan to the liver, with subsequent filtration of the drug after it passes through the liver and before it enters the systemic circulation, in order to reduce potential systemic toxicity. Such a system is described, for example, in U.S. Pat. No. 5,069,662 to Bodden, which is herein incorporated by reference. The Delcath PHP System Kit, for example, utilizes a series of catheters and filters to target drug delivery to the liver and to filter it out before it reaches systemic circulation.

In this example of the use of some embodiments of the intention, a hepatic artery drug infusion catheter is inserted through the skin into one of the femoral arteries and advanced into the hepatic artery so that the tip is positioned to deliver drug to the liver. Utilizing the Delcath Introducer Set, the Delcath Double Balloon Catheter is inserted through the skin into a femoral vein and advanced through the inferior vena cava to the liver. The balloons on the Delcath Double Balloon Catheter are inflated so as to isolate the blood flowing out of the liver, preventing its circulation to the rest of the body. Melphalan, as the chemotherapeutic agent, is infused into the liver through the infusion catheter. That portion of the drug which is not taken up by the liver and tumors flows with the blood out of the body through the Delcath Double Balloon Catheter. This blood is pumped by an external blood pump through filters. The filtered blood returns to the patient through a venous return sheath. At the end of the procedure, catheters are removed and normal circulation is restored.

Media that can be used with different embodiments of the invention include any media that requires a priming step to prepare the media from a dry state to a state with fluid medium for filtering in which air bubbles might get trapped. In some embodiments of the invention the media is suitable for filtering blood and removing toxic substances, such as chemotherapy agents. For example, a hydrogel coated activated carbon that has a porous structure is effective in removing organic compound chemotherapy agents from blood. Such a media can be used in some embodiments of the invention in filter cartridges.

The filter cartridge tube can be of a material suitable for the application provided that it can be molded into a suitable form and is appropriate for a particular application. In some embodiments the filter cartridge tube and filter cartridge top and bottom are made of a biologically compatible material. For example, the filter cartridge tube, filter cartridge top, and filter cartridge bottom can be made of a polycarbonate, a polysulfone, an acrylic, and the like. Where the filter apparatus will be used for blood filtration the filter cartridge tube and filter cartridge top and bottom should be made of a hemo-compatible material such as thermoplastics or thermosetting plastics. Such plastics include, for example, polycarbonates, polysulfones, acrylic, polyethylene, polypropylene, polyester, nylon, polycarbonate, and the like. The material may be transparent or opaque, although materials that are at least partially transparent offer some advantages in that the purging of bubbles from the filter media can be easily visualized.

The filter cartridge outer tubes are generally in a cylindrical configuration and it is referred herein as a filter cartridge tube. Filter cartridges generally can have any shape in which filtration can be achieved, and the shape of the filter cartridges can be varied in some embodiments of the invention. For example, rectangular filter cartridges, or other geometrically shaped cartridges, can be used in accordance with some embodiments of the invention.

Although some mechanisms are described herein for switching filter cartridges or filters between a prime state and a filter state, other mechanism are contemplated by this disclosure including computer mechanical interface means and electric means for driving the change between the prime state and the filter state.

Typically, where blood purification is desired, starting from sterile dry filter media and the media is hydrated with saline or any other physiologically compatible solution. On hydrating the media in this way, air bubbles form within the media. The operator needs to then attempt to dislodge air bubbles. Purging the bubbles from the system can take some time. In the present invention, a changing of the volume of the filter cartridge enables the operator to achieve a rapid purging of bubbles from the media, without other time consuming priming procedures.

### Filter Media

The filter apparatus disclosed herein can be used with a variety of filter media. Throughout this disclosure, the filter media used ordinarily undergoes a priming procedure to be at its most effective. Embodiments of the invention disclosed herein are applicable to any filter media that on being prepared for filtration would benefit from a priming step in which trapped air bubbles, or other gases, is removed from the media.

In some embodiments, a filter media for removing toxic compounds from a biological fluid is used. In some embodiments, a filter media used in blood detoxification, or purification is used. In some embodiments, the filter media is a carbon, or activated carbon, based adsorbent material. In some embodiments, the filter media extracts or removes toxic compounds from blood. In some embodiments the filter media for extracting toxic compounds is a carbon based adsorbent material coated with a biocompatible synthetic, natural or chemical coating or modification, that can render the carbon based adsorbent material hemo-compatible while at the same time maintaining the adsorbent capacity of the carbon-based adsorbent. Such coatings include, for example, methacrylates. In some embodiments, the filter media is made up of polymer coated activated carbon cores, for example, granules or spheres coated with a polymer coat to render them cores hemo-compatible.

In some embodiments, the carbon cores have a diameter of from about 0.45 mm to about 1.15 mm. In some embodiments of the invention the carbon cores have an average diameter of about 0.73 mm.

In some embodiments of the invention the polymer coated carbon cores are coated with a semipermeable polymer coating comprised of material selected from cellulose, a methacrylate polymer, and combinations thereof. In some embodiments of the invention the polymer coating is selected from the group consisting of polymethylmethacrylate (PMMA), polyethylmethacrylate (PEMA), polyhydroxyethyl-methacrylate (PHEMA) and combinations thereof.

The coating that surrounds the carbon cores in some embodiments is comprised of poly(2-hydroxyethyl methacrylate). The thickness of the coating that covers the particles is determined largely by the mass ratio of carbon cores to poly(2-hydroxyethyl methacrylate) used in the coating process.

### Example

### Priming a Variable Volume Filter

In this example the procedure used to prime a variable volume filter is described. A filter with a prime state volume of 1000 cubic centimeters, and a filter state volume of 575 cubic centimeters was tested with a filter media volume of 540 ml measured by a dry bulk method. The filter was attached to a pump and reservoir filled with saline. The pump was run at a slow flow rate 1000 rpm equating to approximately 250 ml per minute. Once the filter volume is filled saline, air was obviously present within and throughout the filter media as it escapes from the microporous filter media internal structure and clings to the surface of the filter media beads. As the pump speed is increased the filter media becomes suspended in the upwards flowing column. of saline. The apparent volume of filter media expanded as saline filled and flowed through the space between filter media particles. The flowing saline dislodged and carried the air bubbles upwards where the air can escape from the filter volume.

When the flow rate was increased to 2000 rpm equating to approximately 500 ml per minute, the filter media was lifted to the top portion of the filter volume. When the pump was stopped the filter media fell in sequence in the housing starting at lower boundary of the filter media to saline gradually working its way to the top. The filter media particles fell in the column as air was expelled from the internal structure of the media and small air bubbles attached by cohesive surface tension bonds released from the media's surface reducing the media particle's buoyancy. As the media particles fell, a bed of media built up in the lower volume of the cartridge. Once all the media had fallen though the column, the media was free of air. The process was repeated a few times to insure all of the air was removed. The filter cartridge was then placed into the filter state to reduce the filter cartridge internal volume 40% to 575 cubic centimeters. This allowed for approximately 35 cubic centimeters of available space between the filter media volume and filter cartridge volume for expansion of the media coating, as the coating hydrates in the saline and to allow adequate flow space for the blood. The filter was then ready for blood filtration.

A number of embodiments have been described and are to be considered as illustrative and not restrictive. It will be understood that various modifications may be made without departing from the spirit and scope of the invention and that the claims should not be limited to the versions and embodiments described herein.

What is claimed is:

1. A filter apparatus for removing contaminants from a fluid, comprising:
a cartridge having a first end and a second end, an inlet and an outlet, and an internal chamber having an adjustable volume;
media for extracting the contaminants from the fluid contained within the internal chamber of the cartridge, and
means for adjusting the volume of the internal chamber.

2. The filter apparatus of claim 1, wherein the internal chamber can be adjusted to between a prime state and a filter state.

3. The filter apparatus of claim 1, wherein the means for adjusting the volume of the internal chamber comprises a piston engaged with the walls of the internal chamber that can be moved within the internal chamber.

4. The filter apparatus of claim 1, wherein the means for adjusting the volume of the internal chamber comprises telescopically arranged tubes that can move in and out of each other.

5. The filter apparatus of claim 1, wherein the means for adjusting the volume of the internal chamber comprises a tube or other structure made from an elastomeric material that can stretch and recover in size.

6. The filter apparatus of claim 1, comprising two or more filter cartridges.

7. The filter apparatus of claim 1, wherein the filter media comprises activated carbon.

8. The filter apparatus of claim 7, wherein the filter media is hydrogel coated activated carbon.

9. The filter apparatus of claim 1 wherein the contaminant to be removed from the fluid is a chemotherapy agent.

10. The filter apparatus of claim 1, wherein the fluid is a biological fluid.

11. The filter apparatus of claim 1, wherein the biological fluid is blood.

12. An extracorporeal blood filtration set up comprising a filter apparatus according to claim 1.

13. A method for priming a filter cartridge containing filter media contained within the filter cartridge in an internal chamber, comprising
providing the filter cartridge in a prime state,
introducing fluid to hydrate the filter media;
pumping fluid through the internal chamber of the filter cartridge, and
reducing the volume of the internal chamber of the filter cartridge to a filter state, thus providing a primed filter cartridge.

14. The method of claim 13, wherein the filter media is hydrated over a period of up to 30 minutes.

15. The method of claim 14, wherein the fluid is saline solution.

16. The method of claim 14, wherein the filter media comprises activated carbon.

17. The method of claim 16, wherein the filter media is hydrogel coated activated carbon.

18. An adjustable filter apparatus for removing toxic compounds from a biological fluid, comprising:
a cartridge which comprises two telescopically placed tubes that together form an internal chamber having an adjustable internal volume, wherein the two telescopically placed tubes are coaxially moveable, arranged longitudinally and sealingly engaged;
media for extracting toxic compounds from the biological fluid contained within the internal chamber of the cartridge, and
means for adjusting the volume of the internal chamber.

19. The adjustable filter apparatus of claim 18, wherein the means for adjusting the volume of the internal chamber is a hand wheel drive screw adjuster.

20. The adjustable filter apparatus of claim 18, wherein the means for adjusting the volume of the internal chamber is lever adjuster.

21. The adjustable filter apparatus of claim 18, wherein the means for adjusting the volume of the internal chamber is a hand wheel and scissor drive adjuster.
